(19) United States
(12) Patent Application Publication
(10) Pub. No.: US 2025/0390327 A1
(43) Pub. Date: Dec. 25, 2025

(54) APU VIRTUAL ENGINE HARDWARE INTERFACE

(71) Applicant: MEDIATEK INC., Hsinchu City (TW)

(72) Inventors: Chuan-Hung Wang, Hsinchu City (TW); Chung-Lun Huang, Hsinchu City (TW); Hsin-Hao Chung, Hsinchu City (TW); Yuan-Che Hsu, Hsinchu City (TW); Kuan-Chun Chen, Hsinchu City (TW); Ping-Yi Hsu, Hsinchu City (TW)

(21) Appl. No.: 18/964,741

(22) Filed: Dec. 2, 2024

Related U.S. Application Data
(60) Provisional application No. 63/661,639, filed on Jun. 19, 2024.

(51) Int. Cl. G06F 9/455; G06F 3/14

(52) U.S. Cl. CPC G06F 9/45558; G06F 3/14; G06F 2009/45579

(57) ABSTRACT

In an aspect of the disclosure, an artificial intelligent processing unit (APU) is provided. The APU comprises multiple hosts, multiple external data processing accelerator (EDPA) interfaces respectively coupled to the multiple hosts, and at least one EDPA optionally coupled to the multiple EDPA interfaces. The multiple EDPA interfaces are configured as interfaces between the multiple hosts and the at least one EDPA, and the number of the EDPA interfaces is more than the number of the at least one EDPAs.

### TECHNICAL FIELD

This application claims the benefit of U.S. provisional application Ser. No. 63/661,639, filed Jun. 19, 2024, the subject matters of which are incorporated herein by references.

The disclosure relates in general to artificial intelligent process unit (APU) virtual engine hardware interfaces, and more particularly, to techniques of methods and apparatuses about schemes to have an application of external data processing accelerator (EDPA) interfaces for coupling hosts (modules) and EDPAs in an APU.

### BACKGROUND

The need of application of artificial intelligent processing unit (APU) increases explosively in recent years, which the need of performance also increases the complexity of the APU, and increases the number of main hardware elements (hosts or modules) of APU to perform different Al processing functions. The APU also needs multiple assistant hardware, such as external data processing accelerators (EDPAs), to communicate with the main hardware to complete the functions. Currently, the main hardware connects to the assistant hardware directly, thus more main hardware needs more assistant hardware. However, more required number of assistant hardware (such as EDPAs) means additional hardware costs. Thus, there are needs for fulfilling the system requirement of APU while keeping hardware cost as low as possible.

### SUMMARY

The present disclosure describes techniques for application of external data processing accelerator (EDPA) interfaces for coupling hosts (modules) and EDPAs in APU, which the EDPA interfaces are configured as interfaces between the hosts (modules) and the EDPAs, and simulate a required EDPA number corresponding to a number of hosts.

The first aspect of the present disclosure features an artificial intelligent processing unit (APU). The APU comprises multiple hosts, multiple external data processing accelerator (EDPA) interfaces respectively coupled to the multiple hosts, and at least one EDPA optionally coupled to the multiple EDPA interfaces. The multiple EDPA interfaces are configured as interfaces between the multiple hosts and the at least one EDPA, and the number of the EDPA interfaces is more than the number of the at least one EDPA.

The second aspect of the present disclosure features a method for virtual hardware interface. The method comprises identifying the number and types of multiple hosts of an APU. The method also comprises configuring a corresponding number of EDPA interfaces of the APU for optionally coupling the multiple hosts according to the number and the types of the multiple hosts. The method also comprises coupling at least one EDPA of the APU to the EDPA interfaces. The EDPA interfaces are configured as interfaces between multiple hosts and the at least one EDPA, and the number of the EDPA interfaces is more than the number of the at least one EDPA.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a block diagram illustrating an example APU, according to some implementations of the present disclosure.

FIG. 2 is a block diagram illustrating another example APU, according to some implementations of the present disclosure.

FIG. 3A is a block diagram illustrating yet another example APU, according to some implementations of the present disclosure.

FIG. 3B is a diagram illustrating an example procedure for application of EDPA interface (HSE) of the APU of FIG. 3A, according to some implementations of the present disclosure.

FIG. 3C is a diagram illustrating an example procedure for application of EDPA interface (CBFC) of the APU of FIG. 3A, according to some implementations of the present disclosure.

FIG. 4 is a flowchart of a method (process) for configuring virtual engine hardware interface (EDPA interfaces) for hosts, according to some implementations of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms “comprise,” “comprising,” “include,” “including,” “has,” “having,” etc. used in this specification are open-ended and mean “comprises but not limited.” The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

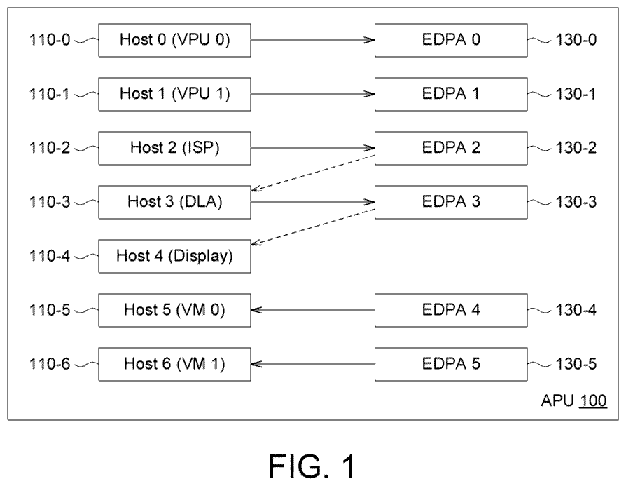

FIG. 1 is a block diagram illustrating an example APU 100, according to some implementations of the present disclosure. The APU 100 includes hosts (or modules) 110-0 to 110-6 and corresponding EDPAs (external data processing accelerator(s)) 130-0 to 130-5. The APU 100 also needs multiple of EDPAs, such as EDPAs 130-0 to 130-5, for coupling hosts 110-0 to 110-6. In this disclosure, Host 0 (VPU (Vision Processing Unit) 0) 110-0 and Host 1 (VPU1) 110-1 respectively control EDPA 0 130-0 and EDPA 1 130-1 directly.

Additionally, in the case of the Host 2 (ISP (Image Signal Processor)) 110-2, Host 3 (DLA (Deep Learning Accelerator)) 110-3 and Host 4 (display) 110-4, the raw image data (or image signal) obtained by the Host 2 (ISP) 110-2 is configured to be sent to EDPA 2 130-2 for processing, then the Host 3 (DLA) 110-3 accesses the processed data from the EDPA 2 130-2 and sends data to EDPA 3 130-3 for further processing, which then the host 4 (display) can receive then display image data from the EDPA 3 130-3 and display it on the screen. Thus, 2 more EDPAs (EDPA 3 130-3 and EDPA 4 130-4) are required.

Moreover, in the case of the Host 5 VM (Virtual Machine) 0 110-5 and the Host 6 (VM 1) 110-6, to fulfill the number of EDAP(s) required for two VMs, 2 more EDPAs (EDPA 4 130-4 and EDPA 5 130-5) are required.

Accordingly, in the implementation of FIG. 1, each host communicates with each EDPA directly, so at least 6 EDPAs (130-0 to 130-5) are required. More hosts need more EDPAs, thus may increase hardware costs. In FIG. 1, 6 EDPAs (130-0 to 130-5) are configured for 7 Hosts to satisfy the communication requirements of the 7 Hosts, a smaller number of EDPAs (e.g., 1 or 2) may be sufficient to fulfill the system requirement of APU.

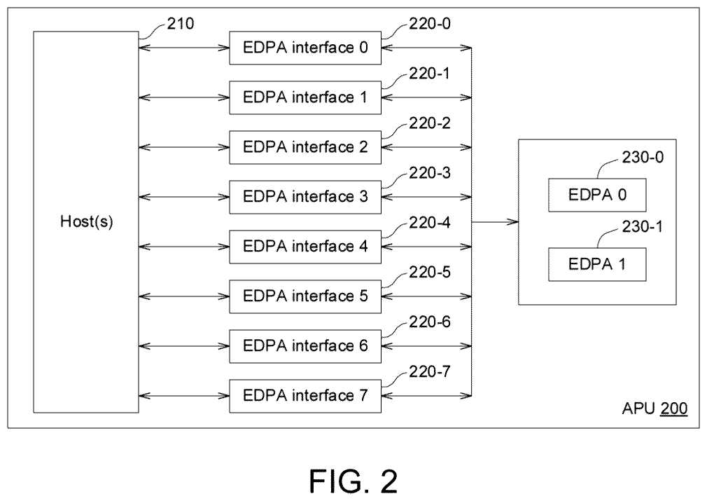

To decrease the number of EDPAs while fulfilling system requirement of APU, the techniques of virtual engine hardware interface (EDPA interface) is provided by the present disclosure, and will be detailed described referring to FIGS. 2 to 4 as follows.

FIG. 2 is a block diagram illustrating another example APU 200, according to some implementations of the present disclosure. The APU 200 includes hosts (or modules) 210 and 2 EDPAs (EDPA 0 230-0 and EDPA 1 230-1). The APU 200 also includes EDPA interfaces 220-0 to 220-7 coupled between the hosts 210 and 2 EDPAs (EDPA 0 230-0 and EDPA 1 230-1). By the techniques of APU virtual engine hardware interface (such as EDPA interfaces 220-0 to 220-7) design according to some implementations of the present disclosure, the number of EDPA interface can be M (M=8 in the case of FIG. 2), which M is sufficient to fit the communication requirement of the Hosts. The number of EDPA (can also be referred as EDAP engine) be N (N=2 in the case of FIG. 2), which N is sufficient to fit the system requirement of the APU. The number of EDPA interface M is greater than the number of EDPA N. For the Hosts, they will misunderstand M as the number of EDPAs. The number of EDPA interface M can be adjusted corresponding to the number of hosts to fit the communication requirement of the hosts, and the actual number of EDPA N can be adjusted corresponding to the system requirement of the APU, such as the product levels, costs, &etc., for example, N=1 for low-end products, N=2 for mid-end products or N=3 for high-end products.

By the design of virtual engine hardware interface (EDPA interface) in FIG. 2, the actual number of EDPAs needed in the APU 200 can be decreased compared with the APU 100.

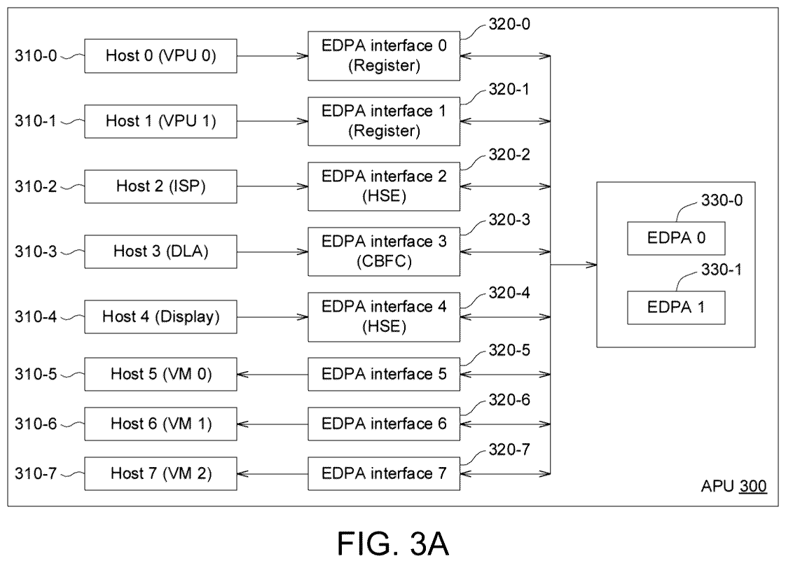

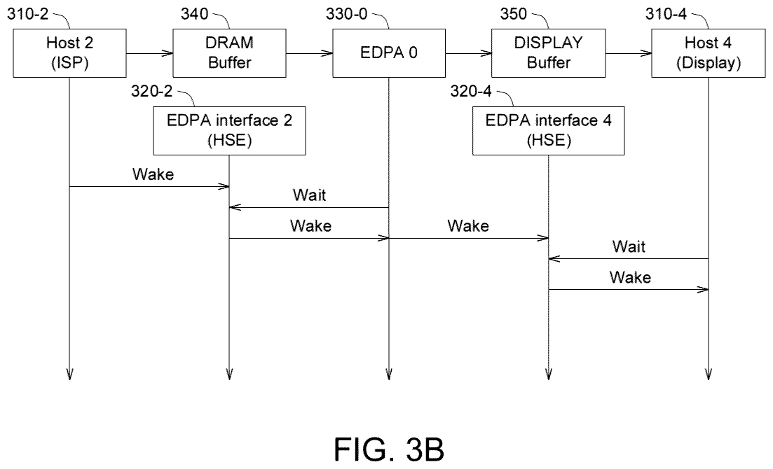

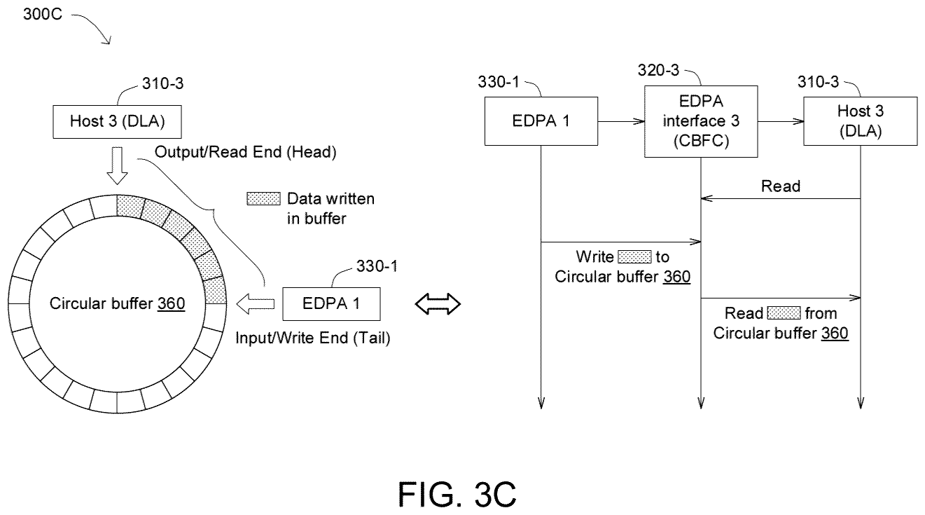

FIG. 3A is a block diagram illustrating yet another example APU 300 which is an example of the APU 200, according to some implementations of the present disclosure. In the example of FIG. 3A, the APU 300 includes 8 hosts, Host 0 (VPU 0) 310-0, Host 1 (VPU 1) 310-1, Host 2 (ISP) 310-2, Host 3 (DLA) 310-3, Host 4 (Display) 310-4, Host 5 (VM0) 310-5, Host 6 (VM1) 310-6, and Host 7 (VM2) 310-7. The APU 300 also includes eight EDPA interfaces, EDPA interface 0 (Register) 320-0, EDPA interface 1 (Register) 320-1, EDPA interface 2 (HSE) 320-2, EDPA interface 3 (CBFC) 320-3, EDPA interface 4 (HSE) 320-4, EDPA interface 5 320-5, EDPA interface 6 320-6, EDPA interface 7 320-7. The APU 300 also includes two EDPAs, EDPA 0 330-0 and EDPA 1 330-1. As shown in FIG. 3A, the eight hosts connect with the eight EDPA interfaces, and the eight EDPA interfaces connect with the two EDPAs, which means total eight hosts share the two EDPAs through the eight EDPA interfaces.

As shown in FIG. 3A, the APU 300 includes the Host 0(VPU 0) 310-0 and the Host 1 (VPU 1) 310-1 respectively coupled to EDPA interface 0 (Register) 320-0 and EDPA interface 1 (Register) 320-1. The APU 300 also includes two EDPAs (EDPA 0 330-0 and EDPA 1 330-1). In this case, EDPA interface 0 (Register) 320-0 and EDPA interface 1 (Register) 320-1 are configured as registers which are the region used to store the instruction to control the hardware (EDPA 0 330-0 and EDPA 1 330-1) form the hosts (the Host 0 (VPU 0) 310-0 and the Host 1 (VPU 1) 310-1). In an example, EDPA 0 330-0 is enabled to read instructions from EDPA interface 0 (Register) 320-0 or EDPA interface 1 (Register) 320-1 to execute the instructions, and put the execution result to EDPA interface 0 (Register) 320-0 or EDPA interface 1 (Register) 320-1 correspondingly, which are correspondingly accessed by the Host 0 (VPU 0) 310-0 or the Host 1 (VPU 1) 310-1. Similarly, EDPA 1 330-1 is enabled to read instructions from EDPA interface 0 (Register) 320-0 or EDPA interface 1 (Register) 320-1 to execute the instructions, and put the execution result to EDPA interface 0 (Register) 320-0 or EDPA interface 1 (Register) 320-1 correspondingly, which are correspondingly accessed by the Host 0 (VPU 0) 310-0 or the Host 1 (VPU 1) 310-1.

Similarly, the APU 300 also includes the Host 2 (ISP) 310-2 and the Host 4 (Display) 310-4 respectively coupled to EDPA interface 2 (HSE (Hardware Sync Engine)) 320-2 and EDPA interface 4 (HSE) 320-4. In this case, EDPA interface 2 (HSE) 320-0 and EDPA interface 4 (HSE) 320-4 are configured as hardware sync engine, which will be detailed described referring to FIG. 3B as follows.

FIG. 3B is a diagram illustrating an example procedure 300B for application of EDPA interface (HSE) (320-2 and 302-4) of the APU 300 of FIG. 3A, according to some implementations of the present disclosure. The Hardware sync engine (HSE) is a hardware used to sync the operations order between two hardware, such as between the Host 2 (ISP) 310-2 and EDPA 0 330-0 or between EDPA 0 330-0 and the Host 4 (Display) 310-4, as shown in FIGS. 3A and 3B. When the Host 2 (ISP) 310-2 sends raw image data to DRAM buffer 340, a wake signal is also sent from the Host 2 (ISP) 310-2 to the EDPA interface 2 (HSE) 320-2. Then, the EDPA interface 2 (HSE) 320-2 informs the EDPA 0 330-0 by a wake signal while the EDPA 0 330-0 being idling (by sending a wait signal from the EDPA 0 330-0 to the EDPA interface 2 (HSE) 320-2), and the EDPA 0 330-0 is able to read raw image data from the DRAM buffer 340.

Sequentially, when the EDPA 0 330-0 transmits processed image data to a display buffer 350, a wake signal is also sent from the EDPA 0 330-0 to the EDPA interface 4 (HSE) 320-4. Then, the EDPA interface 4 (HSE) 320-4 informs the host 4 (display) 310-4 with a wake signal while the host 4 (display) 310-4 is idling (by sending a wait signal from the host 4 (display) 310-4 to the EDPA interface 4 (HSE) 320-4), and the host 4 (display) 310-4 is able to read and display the image data on the screen. It can be understood that it doesn't matter for the order of wake signal (from Host 2 (ISP) 310-2 to EDPA interface 2 (HSE) 320-2 or from EDPA 0 330-0 to EDPA interface 4 (HSE) 320-4) and wait signal (from EDPA 0 330-0 to EDPA interface 2 (HSE) 320-2 or from host 4 (display) 310-4 to EDPA interface 4 (HSE) 320-4), but the wake signal (from EDPA interface 2 (HSE) 320-2 to EDPA 0 330-0 or from EDPA interface 4 (HSE) 320-4 to host 4 (display) 310-4) will back to EDPA 0 330-0 after the wait signal (from EDPA 0 330-0 to EDPA interface 2 (HSE) 320-2 or from host 4 (display) 310-4 to EDPA interface 4 (HSE) 320-4) is issued.

Referring back to FIG. 3A, the APU 300 also includes the Host 3 (DLA (Deep Learning Accelerator)) 310-3 coupled to EDPA interface 3 (CBFC (Circular Buffer Controller)) 320-3. In this case, EDPA interface 3 (CBFC) 320-3 is configured as circular buffer controller, which will be detailed described referring to FIG. 3C as follows.

FIG. 3C is a diagram illustrating an example procedure 300C for application of EDPA interface 3 (CBFC) 320-3 of the APU 300 of FIG. 3A, according to some implementations of the present disclosure. The circular buffer controller (CBFC) is the hardware used to handle the circular buffer 360 operations between two hardware elements, such as between the Host 3 (DLA) 310-3 and the EDPA 1 330-1. The circular buffer 360 is a data structure that uses a single, fixed-size buffer as if it were connected end-to-end. When one storage element (for storing data) of circular buffer is used, no location change is needed for the rest of storage elements. The Host 3 (DLA) 310-3 can read information about the circular buffer 360 from the EDPA interface 3 (CBFC) 320-3, such that when the EDPA 1 330-1 writes data into the circular buffer 360, the Host 3 (DLA) 310-3 is able to read data from the circular buffer 360 in the meantime. Also, the EDPA 1 330-1 can write data into the circular buffer 360, until the circular buffer 360 is full, and the write operation of EDPA 1 330-1 can be informed by the EDPA interface 3 (CBFC) 320-3. Similarly, the Host 3 (DLA) 310-3 is able to read data from the circular buffer 360 until the circular buffer 360 is empty, and the read operation of Host 3 (DLA) 310-3 can be informed by the EDPA interface 3 (CBFC) 320-3.

Referring back to FIG. 3A, the APU 300 also includes the Host 5 (VM (Virtual Machine) 0), the Host 6 (VM 1) and the Host 7 (VM 2) respectively coupled to the EDPA interface 5 320-5, the EDPA interface 6 320-6 and the EDPA interface 7 320-7. In this case, the EDPA interfaces 5 to 7 is configured as interfaces for VMs. VM always used in automobile field. As discussed above, to fulfill the number of hardware (such EDAPs) required for each VM, to fit the system requirement of the APU, when the number of hardware (such as EPDAs) is insufficient for the number of VMS, the software of the system (such as APU) must involve as being the arbiter, which causes performance degrade. The EDPA interface 5 320-5, the EDPA interface 6 320-6 and the EDPA interface 7 320-are configure to simulate the corresponding required number of hardware (such as required number of EDPAs) for the Host 5 (VM (Virtual Machine) 0), the Host 6 (VM 1) and the Host 7 (VM 2), which preventing the performance degrading as discussed above.

Accordingly, by the design of virtual engine hardware interface (EDPA interface) referring to FIGS. 3A to 3C, the performance (system requirement) of the APU 300 and the hardware cost requirements (less number of EDPA) can be both fulfilled. In other words, by the design of virtual engine hardware interface (EDPA interface), the implementations of this disclosure can fulfill the system requirement of APU while keep hardware cost as low as possible.

The term, “engine” in this disclosure, can be referring to APU hardware computing units, such as VPU, DLA, EDPA, and the likes.

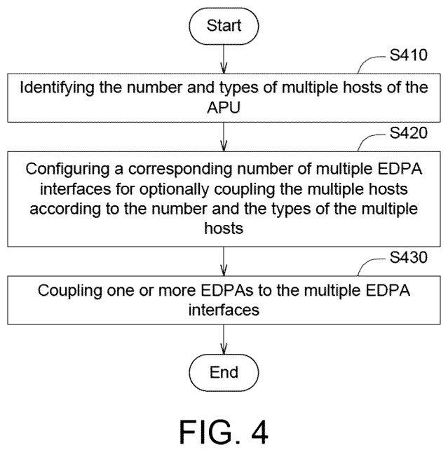

FIG. 4 is a flowchart of a method (process) 400 for configuring virtual hardware interface (EDPA interfaces) for hosts, according to some implementations of the present disclosure. The method (process) 400 can be executed by any device (such as, a processor) coupling to or within an APU. In step S410, a device within an APU for example, identifies the number and types of a plurality of hosts of the APU. The types of the multiple hosts may include at least one of an ISP, a display, a DLA, a VPU, and a VM, as discussed above referring to FIGS. 3A to 3C. In step S420, the device within the APU for example, configures a corresponding number of EDPA interfaces for optionally coupling the multiple hosts according to the number and the types of the multiple hosts. In step S430, the device within the APU for example, couples one or more EDPAs to the EDPA interfaces. The EDPA interfaces are configured as interfaces between the plurality of hosts and the one or more EDPAs, and the number of the EDPA interface is more than the number of EDPAs.

In this disclosure, the EDPA interfaces replace the EDPAs to communicate with the plurality of hosts, thus only the number of the EDPAs interfaces need to fit the communication requirements of the Hosts, the actual number (that is, the second number) of EDPAs only needs to fulfill the system requirement of the APU, thus can be reduced.

In certain configurations, when the types of the multiple hosts includes at least one VPU, at least one EDPA interface of the multiple EDPA interfaces is configured as a register used to store instructions accessible by the at least one VPU for controlling at least one EDPA of the one or more EDPAs.

In certain configurations, when the types of the multiple hosts includes an ISP and an display, two EDPA interfaces of the multiple EDPA interfaces are configured as hardware sync engines (HSEs) respectively coupled to the ISP and the display.

In certain configurations, one EDPA interface of the two EDPA interfaces coupled to the ISP is configured to sync operations order between the ISP and at least one EDPA of the one or more EDPAs. While the ISP sending raw image data to a DRAM buffer, the one EDPA interface informs the at least one EDPA, and then the at least one EDPA is enabled to read the raw image data from the DRAM buffer.

In certain configurations, one EDPA of the two EDPA interfaces coupled to the display is configured to sync operations order between at least one EDPA of the one or more EDPAs and the display. While the at least one EDPA sending processed image data to a display buffer, the one EDPA interface informs the display, and then the display is enabled to read and display the processed image data and raw image data.

In certain configurations, when the types of the multiple hosts includes at least one DLA, at least one EDPA interface of the multiple EDPA interfaces are configured as a circular buffer controller (CBFC) used to control operations, between the at least one DLA and at least one EPDA of the one or more EDPAs, of at least one circular buffer.

In certain configurations, the at least one DLA is enabled to read information about the circular buffer from the at least one EDPA interface. When the at least one EPDA writes data into the circular buffer, the DLA is enabled to read the data according to the information of circular buffer.

In certain configurations, the at least one EDPA is enabled to write data into the circular buffer, until the circular buffer is full, which the at least one EDPA is informed by the at least one EDPA interface. The DLA is enabled to read the data from the circular buffer until the circular buffer is empty, which the DLA is informed by the at least one EDPA interface.

In certain configurations, when the types of the multiple hosts includes a number of VM, a corresponding number of EDPA interface of the multiple EDPA interfaces are configured to couple the number of VM, and the corresponding number of EDPA interface is identical to the number of VM.

A system (such as, the APU) may encompass all apparatus, devices, and machines for processing data, including by way of example a programmable processor, a computer, or multiple processors or computers. A system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

Processors, processing units, engines, and accelerators suitable for the execution of a computer program include, by way of example, both general and special purpose microprocessors, and any one or more processors of any kind of digital computer. Generally, a processor, a processing unit, an engine, or an accelerator will receive instructions and data from a read only memory or a random access memory or both. The essential elements of a computer can include a processor, a processing unit, an engine, or an accelerator for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks. The processor, the processing unit, the engine, or the accelerator and the memory can be supplemented by, or incorporated in, special purpose logic circuitry, such as other processors, processing units, engines, or accelerators.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. An artificial intelligent processing unit (APU), comprising:
a plurality of hosts;
a plurality of external data processing accelerator (EDPA) interfaces, respectively coupled to the plurality of hosts; and
at least one EDPA, optionally coupled to the plurality of EDPA interfaces,
wherein the plurality of EDPA interfaces are configured as interfaces between the plurality of hosts and the at least one EDPA, and the number of the plurality of EDPA interfaces is more than the number of the at least one EDPA.

2. The APU of claim 1, wherein the plurality of hosts comprise at least one of an image signal processor (ISP), a display, a deep learning accelerator (DLA), a vision processing unit (VPU), and a virtual machine (VM).

3. The APU of claim 1, wherein upon determining that the plurality of hosts comprise at least one VPU, at least one of the plurality of EDPA interfaces is configured as a register used to store instructions accessible by the at least one VPU for controlling at least one of the at least one EDPA.

4. The APU of claim 1, wherein upon determining that the plurality of hosts comprise an ISP and a display, two EDPA interfaces of the plurality of EDPA interfaces are configured as hardware sync engines (HSEs) respectively coupled to the ISP and the display.

5. The APU of claim 4, wherein one of the two EDPA interfaces coupled to the ISP is configured to sync operations order between the ISP and at least one of the at least one EDPA,
wherein while the ISP sending raw image data to a DRAM buffer, the one EDPA interface coupled to the ISP informs the at least one of the at least one EDPA, and then the at least one of the at least one EDPA is enabled to read the raw image data from the DRAM buffer.

6. The APU of claim 4, wherein one of the two EDPA interfaces coupled to the display is configured to sync operations order between at least one of the at least one EDPA and the display,
wherein while the at least one EDPA sending processed image data to a display buffer, the one EDPA interface coupled to the display informs the display, and then the display is enabled to read and display the processed image data and raw image data.

7. The APU of claim 1, wherein upon determining that the plurality of hosts comprise at least one DLA, at least one of the plurality of EDPA interfaces is configured as a circular buffer controller (CBFC) used to control operations, between the at least one DLA and the at least one EDPA of at least one circular buffer.

8. The APU of claim 7, wherein the at least one DLA is enabled to read information about the circular buffer from the at least one EDPA interface,
wherein, when the at least one EPDA writes data into the circular buffer, the DLA is enabled to read the data according to the information of the at least one circular buffer.

9. The APU of claim 7, wherein the at least one EDPA is enabled to write data into the circular buffer, until the circular buffer is full, which the at least one EDPA is informed by the at least one EDPA interface,
wherein, the DLA is enabled to read the data from the circular buffer until the circular buffer is empty, which the DLA is informed by the at least one EDPA interface.

10. The APU of claim 1, wherein upon determining that the plurality of hosts includes a number of VM, a corresponding number of EDPA interface of the plurality of EDPA interfaces are configured to couple the number of VM, and the corresponding number of EDPA interface is identical to the number of VM.

11. A method for virtual hardware interface, comprising:
identifying the number and types of a plurality of hosts of an APU;
configuring a corresponding number of EDPA interfaces of the APU for optionally coupling the plurality of hosts according to the number and the types of the plurality of hosts; and
coupling at least one EDPA of the APU to the EDPA interfaces,
wherein the EDPA interfaces are configured as interfaces between the plurality of hosts and the at least one EDPA, and the number of the EDPA interfaces is more than the number of the at least one EDPA.

12. The method of claim 11, wherein the types of the plurality of hosts include at least one of an image signal processor (ISP), a display, a deep learning accelerator (DLA), a vision processing unit (VPU), and a virtual machine (VM).

13. The method of claim 11, wherein upon determining that the types of the plurality of hosts comprise at least one VPU, the at least one of the plurality of EDPA interfaces is configured as a register used to store instructions accessible by the at least one VPU for controlling at least one of the at least one EDPA.

14. The method of claim 11, wherein upon determining that the types of the plurality of hosts includes an ISP and a display, two EDPA interfaces of the plurality of EDPA interfaces are configured as hardware sync engines (HSEs) respectively coupled to the ISP and the display.

15. The method of claim 14, wherein one of the two EDPA interfaces coupled to the ISP is configured to sync operations order between the ISP and at least one of the at least one EDPA,
wherein while the ISP sending raw image data to a DRAM buffer, the one EDPA interface coupled to the ISP informs the at least one of the at least one EDPA, and then the at least one of the at least one EDPA is enabled to read the raw image data from the DRAM buffer.

16. The method of claim 14, wherein one of the two EDPA interfaces coupled to the display is configured to sync operations order between at least one of the at least one EDPA and the display,
wherein while the at least one EDPA sending processed image data to a display buffer, the one EDPA interface coupled to the display informs the display, and then the display is enabled to read and display the processed image data and raw image data.

17. The method of claim 11, wherein upon determining that the types of the plurality of hosts comprise at least one DLA, at least one of the plurality of EDPA interfaces is configured as a circular buffer controller (CBFC) used to control operations, between the at least one DLA and the at least one EPDA, of at least one circular buffer.

18. The method of claim 17, wherein the at least one DLA is enabled to read information about the circular buffer from the at least one EDPA interface,
wherein, when the at least one EPDA writes data into the circular buffer, the DLA is enabled to read the data according to the information of the at least one circular buffer.

19. The method of claim 17, wherein the at least one EDPA is enabled to write data into the circular buffer, until the circular buffer is full, which the at least one EDPA is informed by the at least one EDPA interface,
wherein, the DLA is enabled to read the data from the circular buffer until the circular buffer is empty, which the DLA is informed by the at least one EDPA interface.

20. The method of claim 11, wherein upon determining that the types of the plurality of hosts includes a number of VM, a corresponding number of EDPA interface of the plurality of EDPA interfaces are configured to couple the number of VM, and the corresponding number of EDPA interface is identical to the number of VM.
